(19) United States
(12) Patent Application Publication
(10) Pub. No.: US 2003/0205525 A1
(43) Pub. Date: Nov. 6, 2003

(54) Method of soil extraction

(76) Inventor: Blaine F. Severin, Okemos, MI (US)

Correspondence Address: Quarles & Brady, 411 East Wisconsin Avenue, Milwaukee, WI, 53202-4497, US

(21) Appl. No.: 10/257,200

(22) PCT Filed: Apr. 9, 2001
(86) PCT No.: PCT/US01/11578

(51) Int. Cl. B01D 11/04

(52) U.S. Cl. 210/634; 210/639; 134/10; 134/40; 436/178

(57) ABSTRACT

A method of extracting oil-soluble contaminants from soils, sediments, or porous solids is disclosed. In one embodiment, the method comprises the steps of immersing the solid in a fluid comprising a water phase and an oil phase, mixing the phases and allowing the phases to separate, wherein the contaminants are thereby concentrated in the oil phase.

### CROSS-REFERENCE TO RELATED APPLICATION

This application claims priority to U.S. Ser. No. 60/196,530, filed Apr. 11, 2000, which is incorporated by reference herein.

### STATEMENT REGARDING FEDERALLY SPONSORED RESEARCH OR DEVELOPMENT

### BACKGROUND OF THE INVENTION

Complex materials such as clay, sand, loam or humics, are typical components of soil. Due to the varied chemical nature of these materials, it is exceedingly difficult to remove trace surface-loving pollutants such as oil, chlorinated solvents, plasticizers, insecticides, dioxins, and other man-made or naturally occurring pollutants from the soil matrix in a general or universal means. For example, any soil which has been contaminated with polychlorinated biphenyls (PCB's) at a concentration of greater than 49 parts per million dry weight basis are considered contaminated and must either be incinerated or disposed-of in a contained and licensed landfill. Incinerators and landfills are limited in their availability, and are very costly. As such, operators of these units can charge a premium cost typically between $500-1000 per ton of soil (roughly $700-1300/cubic yard). A reliable, low cost, method of removing and concentrating pollutants from soil is needed.

Water-borne surfactants have been used to treat soils. These systems are not in favor because the surfactants generally increase the solubility of the pollutant only slightly in the water phase. This is well below the critical micelle concentration, so it is difficult to remove the pollutant from the water phase. In short, a large volume of polluted water is produced to clean a small volume of soil.

Solvents with a high affinity for target pollutants have been used to extract the pollutant from the soil. Unfortunately, these solvents also have a high affinity for the soil and must be removed from the soil by physical means such as vaporization. Recovery of the solvent usually entails condensation or distillation.

Needed in the art of pollutant removal is an improved method of removing oil-soluble pollutants from solid materials.

### SUMMARY OF THE INVENTION

The present invention pertains to the general field of extracting trace materials from solids. In particular, the invention teaches new methods of removing oily environmental pollutants and contaminants from soils and sediments using a surfactant and oil phase/water phase separation. The contaminant may be an oil, such as petroleum, or oil by-products, such as PAH (poly-aromatic hydrocarbons), or an oil-soluble compound, such as PCB.

The contaminants may be concentrated in the water phase by foam fractionation. Furthermore, a more efficient separation and a higher concentration of contaminant may be separated from the water phase by combining the surfactant with an oil and concentrating the environmental pollutants or contaminants into the oil phase.

More specifically, in one embodiment the present invention is a method of removing polychlorinated biphenyls (PCB's) from lake sediment, bay sediment, and soil using the method described below. Typically, the method comprises the steps of immersing a soil sediment or porous solid in a fluid comprising a water phase and an oil phase, mixing the phases, and allowing the phases to separate, wherein the contaminants are thereby concentrated in the oil phase. In a particularly preferred method of the present invention, the water phase comprises a surfactant with high detergency yet low emulsion carrying capacity.

Alternatively, the contaminated soil or solid may be first contacted with waterborne surfactant. The waterborne surfactant may then be removed from the soil and contacted with oil in a second extraction step.

It is a feature of the present invention that oil soluble contaminants may be concentrated and removed from contaminant bearing solids, such as soils and sediments.

It is another feature of the present invention that the soil sediments may be treated in a batch or semi-batch method.

Other objects, advantages or features of the present invention will become apparent when one reviews the specification, claims and drawings.

### DETAILED DESCRIPTION OF THE SEVERAL VIEWS OF THE DRAWINGS

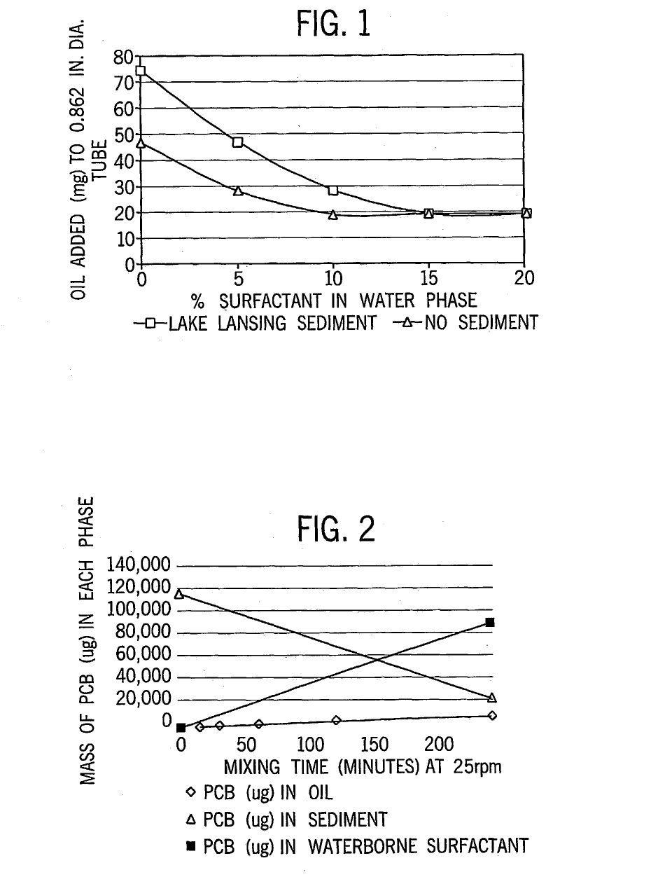

FIG. 1 is a graph describing the amount of oil and surfactant required to form a recoverable oil layer.

FIG. 2 is a graph of a timed mixing study with weathered PCB sample.

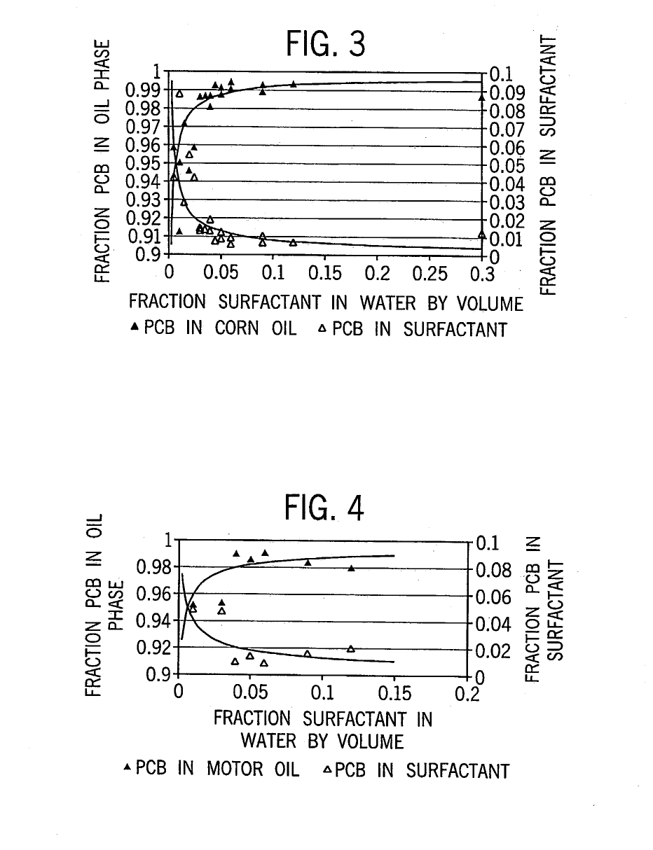

FIG. 3 is a graph of the distribution of PCB mass between 5 ml corn oil and 25 ml waterborne surfactant.

FIG. 4 is a graph of the distribution of PCB mass between 5 ml motor oil and 25 ml waterborne surfactant.

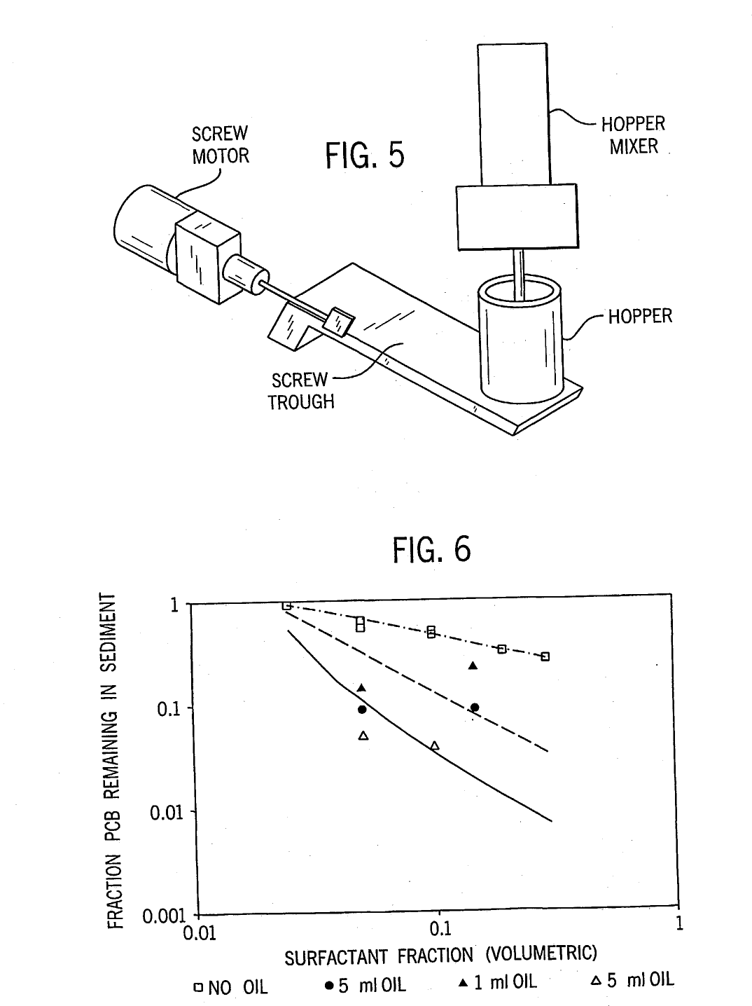

FIG. 5 is a diagram of a laboratory scale screw washer apparatus.

FIG. 6 is a graph of the extraction of PCB from spiked lake sediment.

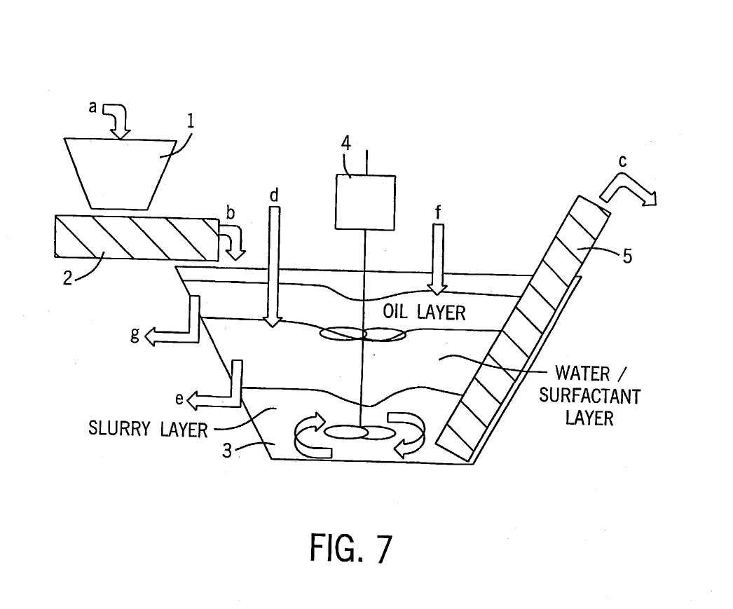

FIG. 7 is a diagram of a continuous or semi-continuous flow extraction reactor.

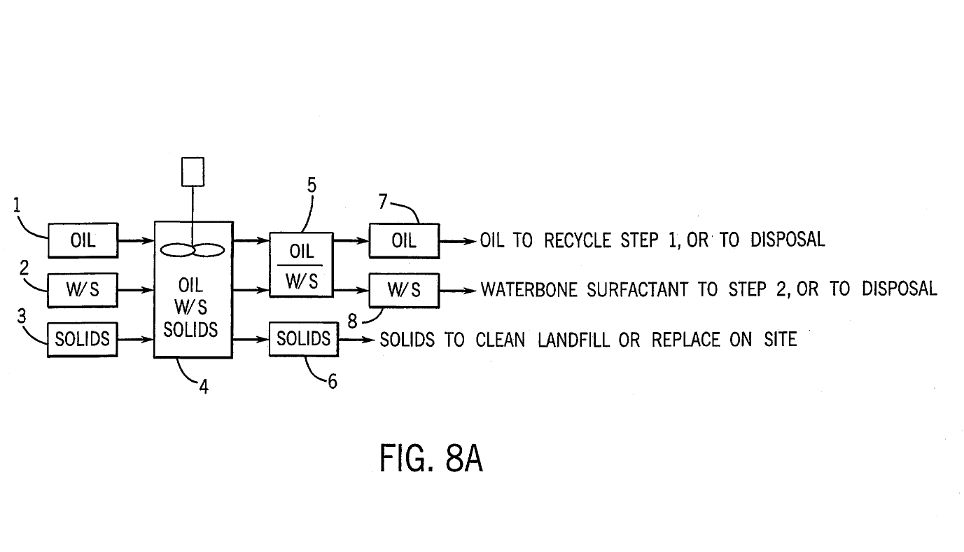

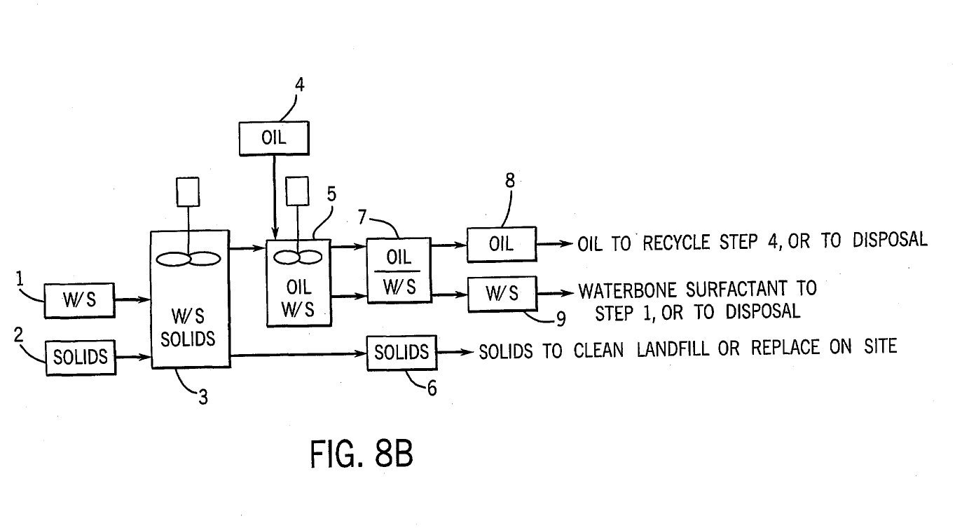

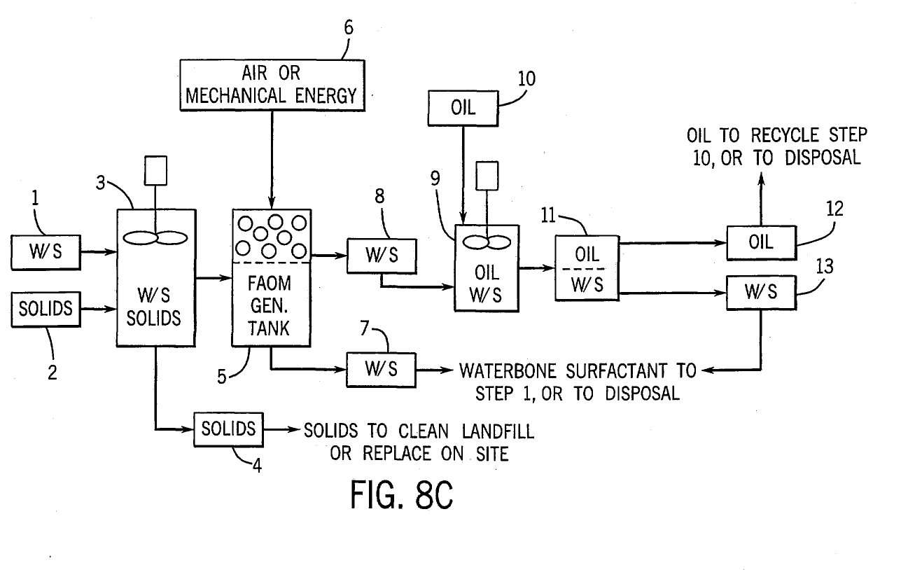

FIGS. 8A, B and C are flow charts illustrating different embodiments of the invention.

### DESCRIPTION OF THE INVENTION

The present invention is a method of extracting oil soluble contaminants from materials such as soils, sediments, or porous solids. Preferably, the method comprises the steps of immersing the solid in a fluid comprising an aqueous phase and an oil phase, mixing the phases, and allowing the phases to separate. The contaminants are thereby concentrated in the oil phase.

Alternatively, the contaminated soil or solid may be first contacted with waterborne surfactant. The waterborne surfactant may then be removed from the soil and contacted with oil in a second extraction step.

By water phase or aqueous phase or waterborne surfactant phase, we mean an aqueous solution capable of removing oily materials or oil from a solid phase by virtue of strong detergency and rejecting the oil or oily material to an oil layer through strong anti-emulsion capacity. The attributes required of the surfactant are demonstrated in Experiments 2, 3, 8 and 9, and exemplified in the commercial product, RHEMA SUPER CONCENTRATED MATRIX (Rhema Products, Inc, Memphis, Tenn.). Solutions of the commercial product, which is approximately 90% water and 10% surfactant and builder by weight, have been successfully tested at ranges of concentration from 0.1% by volume of commercial product in 99.9% water to 100% commercial product in 0% water. By “oily phase” we mean a phase comprised of added oil or oil extracted from the oily contaminant.

As a most preferred version of the present invention, we have discovered a surfactant system that has the unique property of high detergency, yet low emulsion carrying capacity. Detergency is a relative term defining the ability of a surfactant to remove dirt, grease, and oil from solid surfaces. In general, commercial products deemed to have high detergency are products like DAWN dishwashing liquid (Procter and Gamble, Cincinnati, Ohio), TIDE laundry detergent (Procter and Gamble, Cincinnati, Ohio), and JOY dishwashing liquid detergent (Procter and Gamble, Cincinnati, Ohio). The RHEMA SUPER CONCENTRATED MATRIX has detergent qualities similar to DAWN, TIDE and JOY.

Emulsivity is the property to surfactants to stabilize emulsions of oil in water. Emulsion breakers destabilize oil in water to aide in the formation of clear interfaces between distinct oil and water phases. It is noteworthy that most detergents are strong emulsifiers. The present invention, however, requires of the detergent to have anti-emulsion properties. Typical anti-emulsion products rely on high cationic charge density to lower the surface strength of the micelle structure. Examples are mono-valent, di-valent, and tri-valent cationic salts, polyacrylic acids, TRITON RW (Rohm and Haas), and natural polycationic resins such as CMF KITOSAN (Cognis Company).

While most commercial formulators create detergents to have high emulsivity, the existence of the RHEMA SUPER CONCENTRATED MATRIX indicates that detergents with emulsion-breaking properties can be produced. For the purposes of the present invention the detergent must have high detergency like JOY, TIDE or DAWN, but must have emulsion-breaking capacity. By way of example, Experiment 3 shows that a surfactant breaks oil emulsions in water such that a solution of the surfactant minimizes the amount of oil required to develop a clear phase break between oil and water. Solutions from greater than 0% to 15% surfactant cause a decrease in the amount of oil required to define a clear interface as the surfactant dose increases. By way of further experiment, Experiments 8 and 9 show that an oily contaminant such as PCB can be driven from the water phase and concentrated into an established oil phase such that more than a 1% solution of the surfactant causes more than 95% of the contaminant to partition to the oil phase. Any surfactant that shows these types of physical behavior (strong detergency with emulsion breaking capacity) can be used to perform the art of the invention. One example of such a surfactant is SUPER-CONCENTRATED MATRIX, from Rhema Products, Memphis, Tenn. Another example is SANTEC 1000 or SANTEC 2000, Santec Inc. of Farmington Hills, Mich.

Oily materials removed from a solid surface are relatively quickly rejected from a solution of surfactant in water yielding a clear interface of oil and water. The surfactant remains mostly with the water phase. Exemplary systems are described below, especially at FIGS. 5 and 7. Any oily contaminant will partition strongly to the oil phase.

In one embodiment, the present invention is a method of concentrating contaminants via foam fraction. The contaminated solid is mixed with an aqueous/surfactant mixture. The foam fractionation, air or mechanical energy is added to waterborne surfactant, creating a foam phase and a waterborne surfactant phase. The oil or oil soluble materials are concentrated in the foam phase. Removal of the foam from the remainder of the waterborne surfactant caused a concentration in the target compounds known as foam fractionation.

In one embodiment, the invention is a method in which this surfactant system can be used to leach a pollutant from pollutant-contaminated soil by immersing the soil in a water/oil/surfactant mixture, removing the oil contaminant from the soil, and ultimately rejecting the pollutant-bearing oil from the water/surfactant solution. In such a process, the water may be reused with only slight recharging of surfactant and make-up water equivalent to the losses from removal of wetted soil from the reaction vessel. The soil is preferably cleansed of pollutant to a safe level. The oil may be captured and reused until the equilibrium limit between the pollutant level and the soil is reached.

In general, a preferred method of the present invention is exemplified in FIGS. 8A, B and C. FIG. 8A is one embodiment of the invention in which oil (1), waterborne surfactant (2) and solids (3) are contacted in a mixing tank (4). Solids (6) are removed from tank (4) and sent to clean landfill or replaced on site, or sent for a second cleaning in the tank. Waterborne surfactant and oil are removed from tank (4) to an oil/water separator (5) from which the oil (7) is recycled to step 1 or disposed depending on the concentration of contaminant in the oil. Waterborne surfactant is recycled to step 2 or disposed.

FIG. 8B is a second embodiment of the invention in which waterborne surfactant (1) and solids (2) are contacted in a mixing tank (3). Solids (6) from the mixing tank are removed to clean landfill or replaced on site. Waterborne surfactant from tank (3) is contacted with oil (4) in a second mixing tank (5). The emulsion from tank 5 is sent to an oil/water separator (7) from which the oil (8) is recycled to step (4) or disposed. The waterborne surfactant (9) is recycled to step (1) or disposed.

FIG. 8C is a third embodiment of the invention in which waterborne surfactant (1) and solids (2) are contacted in a mixing tank (3). Solids from the mixing tank are sent to clean landfill, replaced at site, or sent back to tank (3) for reprocessing if necessary. Waterborne surfactant from tank (3) is sent to a foam generation tank (5) in which air or mechanical energy are used to create a foam layer and a waterborne surfactant layer. The waterborne surfactant layer (7) is recycled or disposed. The foam layer is sent to a coalescence tank (8) to form a second waterborne surfactant layer. This second waterborne surfactant batch is sent to a second mixing tank (9) and contacted with oil (10). The resultant oil/water emulsion is sent to an oil/water separator (11). The oil (12) is recycled to step (10) or disposed. The waterborne surfactant (13) is recycle to step (1) or disposed.

In a preferred embodiment of the present invention, the following contaminants are removed from soil: PCB, lindane, aldane, DDT, dioxins, polychlorinated terphenyls, atrazine, and chlorinated phenols. Preferably, the contaminants are petroleum products or chlorinated hydrocarbons or a mixture of these products. Contaminants may also be natural such as poly-aromatic hydrocarbons (PAH). Preferably, at least 90% of the contaminant is removed from the soil or solid. More preferably, 95% of the contaminant is removed. Most preferably, 99% is removed.

In a preferred embodiment, the surfactant system is non-toxic and biodegradable, and the oil system may be chosen to be non-petroleum based and non-toxic and biodegradable (for example, a vegetable oil like corn oil). Preferable oils include oil derived from soy, peanuts, canola, oil, or olives. The oil may be derived solely or in part from oily contaminants extracted from the contaminated solid.

The contaminant may be concentrated and the water phase concentration reduced by use of foam fractionation of the water phase wherein the contaminant preferentially partitions to the foam phase.

Mechanical systems may be used to optimize the contact and recovery of the soil, water/surfactant, and oil components.

FIG. 7 is a schematic showing one embodiment of the extraction of the present invention. In FIG. 7, we depict a hopper 1 for storing contaminated solid medium, which is loaded at point (a). The hopper 1 feeds a screw feeder 2 and the solids are delivered to a tank 3 at point (b). A mixer is employed 4, which is depicted here to provide a variable amount of agitation for purposes of mixing the solid slurry, the water/surfactant layer, and the oil layer to the amount needed. Different mixer styles and multiple mixers may be used. The slurry is moved by agitation to the front of the screw feeder 5, which removes decontaminated, wetted solid from the reaction vessel at point (c).

Decontaminated, wetted solid may be further treated and these further treatments are not limited by FIG. 7. Point (d) demonstrates an aspect of the invention wherein recycled or fresh water or water/surfactant or surfactant may be added as needed, or continuously as desired to optimize the extraction. Point (e) demonstrates the possible need to remove water/surfactant layer materials as needed or implied by continuous feed. Water/surfactant removed at (e) may be treated as needed to prepare for recycle or disposal and it is not the intent to limit these further treatments by this disclosure.

Finally, point (f) is included to show that oil may be added as needed or continuously and this oil may be fresh oil or recycled oil. Point (g) is depicted to show that it may be advantageous to remove oil as needed, or as part of a continuous flow scheme. The recovered oil at point (g) may be further treated to prepare it for recycle at point (f) or for disposal as needed. It is not the intent to limit the treatment means of the oil at point (g), and these further treatments are not a part of this disclosure.

A second embodiment of the process may be performed in a method similar to the equipment used in Experiment 10 in which a mixing chamber is used to contact the sediment or soil with the surfactant. The surfactant may then be removed in batch or continuously to a second contact vessel where the surfactant is cleansed with contact with an oil layer. The cleansed surfactant may then be re-applied to the first chamber for further cleansing of the soil. The soil may then undergo a final treatment to remove excess surfactant in a dewatering screw such as used in Experiment 10. Likewise, the soil may be dewatered using standard hydrocyclones or centrifuges or dewatering belt filters or dewatering vacuum filters.

The present invention overcomes the three main problems of the competing processes. We overcome the solubility limitations of surfactant/water systems alone by providing a concentrating medium embodied as the oil. Secondly, we overcome the problem of separation of highly attractive solvent systems from the soil by introducing the surfactant to the process. Thirdly, the oil and surfactant/water means are recyclable using simple gravity or centrifugal forces. Finally, the surfactant has the ability to separate the target compound from water by foam fractionation. Finally, the surfactant has the ability to separate the target compound by foam fractionation.

### EXAMPLES

General Methods

Sediments and Soils

Approximately 2 L of bottom sediments was collected from the N.E. shore area (Lansing Sailing Club property) of Lake Lansing (Haslett, Mich.) in August, 1999. Excess standing water in the sample vessel was decanted the following day. Lake Lansing is a shallow, 420 acre lake with sandy bottom and in a highly neutrified state. The sediment contains humus, detritus, clay, and sand.

Approximately 8 L of sandy loam soil was collected in August 2000. Extraneous materials such as pebbles and sticks were removed. The soil is considered to be a low clay content, sandy-loam.

Approximately 4 gallons of PCB laden sediment from the estuary of the Acushnet River at Buzzard's Bay, New Bedford, Mass., was provided by the United States Environmental Protection Agency, Region One.

PBC Standards and Spiked Samples:

Experiments 1, 2, 4, 5 and 7, the contaminant spike was produced by dissolving 250 mg PCB (Aroclor 1254) into 5 ml acetone followed by dilution with 45 ml deionized water. The spike was then added to 500 g dry weight (roughly 750 g wet weight) of Lake Lansing sediment to produce a laboratory-generated sample with approximately 500 mg/kg dry weight PCB. The spiked sediment was mixed for 15 minutes using a blender (Hamilton Beach) to achieve uniform distribution of the PCBs. The spiked sediment was used as test material in this study.

In Experiments 8, 9, and 10, the PCB stock was purchased from Accustandard, Inc., New Haven, Conn. The standard was prepared in 20 ml aliquots of 10 mg/mL Aroclor 1254 in acetone. In Experiment 10, the spiked soil sample was prepared by adding stock PCB to the low clay, sandy loam soil and mixing for 15 minutes in the blender.

Oils and Surfactant:

The surfactant solution at different concentrations was prepared by adding the appropriate volume of Rhema Products, Memphis, Tenn., Super Concentrated Matrix, into a 200 ml volumetric flask, then making up the remainder of the volume with deionized water.

In Experiments 1, 4, 5, 6, 7, 8, and 10, Mazola corn oil (Bestfoods, Inc.) was used as the organic layer in concentrated form straight from the manufacturer's container.

In Experiment 9, the oil layer was Citgo SAE 30 non-detergent motor oil (Citgo Petroleum Corporation, Tulsa, Okla.).

Extraction and Analysis of PCBs.

Three types of samples were analyzed for PCB's; soil or sediment, waterborne surfactant, and oil. As the project proceeded, new methods were developed to improve the quality of the data, especially in the surfactant and oil phase recovery methods. Table 1 is a summary of the experiments performed and the various methods used for extraction and analysis of PCBs from the samples. The following Methods Shorthand is used: Extraction Method/Laboratory in charge of extraction; Analysis method/Laboratory in charge of analysis.

In Experiment 1, sediment was extracted with Method E1 by the Environmental Quality Laboratory, and the PCBs were analyzed by the Analytical Method A1 by the Environmental Quality Laboratory. The Methods Shorthand is E1/EQL;A1/EQL. Each method is described in detail below.

TABLE 1
Summary of the Various Methods Used for Analysis of
PCB's

| Exp. | | | Water/ | |
|---|---|---|---|---|
| No. | Experiment Title | Solids | surfactant | Oil |
| 1 | Demonstration of the Oil/Surfactant | E1/EQL | E2/EQL | E4/EQL |
| | Method | A1/EQL | A1/EQL | A1/EQL |
| 2 | Sediment Extraction with Surfactant | E1/EQL | E2/EQL | NA |
| | Alone | A1/EQL | A1/EQL | |
| 3 | Critical Phase Concentration of Oil in | NA | NA | NA |
| | 10% Surfactant | | | |
| 4 | PCB's are Preferentially Distributed to the | E1/EQL | E3/MBI | E4/EQL |
| | Foam in a water/surfactant system | A1/EQL | A1/EQL | A1/EQL |
| 5 | Demonstration of closure of mass | E1/EQL | E3/MBI | E4/EQL |
| | balance | A1/EQL | A1/EQL | A1/EQL |
| 6 | Timed Mixing Study with Weathered | E5/MBI | E6/MBI | E7/MBI |
| | Sediment | A2/MSU | A2/MSU | A2/MSU |
| 7 | Effect of oil concentration | E5/MBI | E6/MBI | E7/MBI |
| | | A2/MSU | A2/MSU | A2/MSU |
| 8 | PCB removal from water vs. surfactant | E5/MBI | E6/MBI | E7/MBI |
| | concentration | A2/MSU | A2/MSU | A2/MSU |
| 9 | Motor oil vs. corn oil | E5/MBI | E6/MBI | E7/MBI |
| | | A2/MSU | A2/MSU | A2/MSU |
| 10 | PCB extraction using Hopper apparatus | E5/MBI | E6/MBI | E7/MBI |
| | | A2/MSU | A2/MSU | A2/MSU |

Note: NA = not applicable to experiment
EQL = Environmental Quality Laboratory, Inc., 44075 Phoenix Drive, Sterling Heights, Michigan 48314-1420.
MBI = MBI International, 3900 Collins Rd., Lansing, MI 48910
MSU = Michigan State University, Department of Crop and Soil Sciences, East Lansing, MI 48823

Method E1: Extraction of PCBs from Sediment Samples.

EPA method 8080 was used to extract PCBs from sediment samples. Samples were first dried (24 hours at 105° C.). Dried sediment samples of a known weight were placed in 150 ml beakers. Granular sodium sulfate (EM Science, Gibbstown, N.J. 08027) was added to each sample until the mixture was sandy and free-flowing. Approximately 40 ml of methylene chloride (MeCl₂) was added to each beaker. Each sample was spiked with surrogate, 800 ppb of Decachloro biphenyl (DCB) diluted in methylene chloride. Each sample was then sonicated for 3 minutes. The sonicated samples were filtered through columns packed with sodium sulfate into Turbo Vap tubes. The Turbo Vap tubes were placed into the Turbo Vap unit (Turbo Vap II Concentration Workstation, Zymark Corporation, Hopkington, Mass. 01748) and the samples were concentrated to 1 ml to remove most of the methylene chloride solvent. Approximately 10 ml hexane was added to each Turbo Vap tube and each sample was re-concentrated to 1 ml. The hexane addition step was repeated again. The finally volume of the sample made to was 1.0 ml with hexane. The final concentrate was transferred to a glass sample vial, and 1 μl of an internal standard, Tetrachloro m-xylene (TCMX, 50 ppm) was added to each vial for analysis by gas chromatography (See Method A1 below). If samples required additional cleanup following all the steps outlined in the above procedure, the samples were further filtered through Fluorosil (Activated Magnesium, Sigma Chemical Co., St. Louis, Mo.) cartridge columns.

Method E2: Extraction of PCBs from Liquid Samples.

To extract PCBs from liquid samples, EPA method #8080, water manual liquid-liquid extraction method was used. In this method, liquid sample, 500 ml (if sample is less than 500 ml, add enough water to make up 500 ml, and record the dilution) was poured into a 1000 ml separatory funnel. Each sample was spiked with surrogate, 250 ppb of Decachloro biphenyl (DCB) diluted in methylene chloride. Approximately 100 ml of methylene chloride (MeCl₂) was added to each sample and shaken in the funnel for about 5 minutes. Then the sample was allowed to stand for about 10 minutes. The bottom layer was filtered through columns packed with sodium sulfate into Turbo Vap tube. The top layer was re-extracted with methylene chloride and allowed the funnel to stand for about 10 minutes. The bottom layer was filtered through the sodium sulfate column into a Turbo Vap tube.

The Turbo Vap tube was placed into the Turbo Vap unit (Turbo Vap II Concentration Workstation, Zymark Corporation, Hopkington, Mass. 01748) and the samples were concentrated to 1 ml to remove most of the methylene chloride solvent. Approximately 10 ml hexane was added to each Turbo Vap tube and each sample was re-concentrated to 1 ml. The hexane addition step was repeated again. The final volume of the sample made to was 1.0 ml with hexane. The final concentrate was transferred to a glass sample vial, and 1 μl of an internal standard, Tetrachloro m-xylene (TCMX, 50 ppm) was added to each vial for analysis by gas chromatography (See Method A1 below). If samples required additional cleanup following all the steps outlined in above procedure, the samples were further filtered through Fluorosil (Activated Magnesium, Sigma Chemical Co., St. Louis, Mo.) cartridge column.

This was the method developed by the Environmental Quality Laboratory and used for Experiments 1 and 2. When the surfactant was present in the water phase, an emulsion was created between the water and methylene chloride. After failing to close the mass balance in Experiments 1 and 2, we discovered that no attempts were made to break the emulsion, and that it was discarded. This likely caused a large portion of the PCBs to be missed in the final analysis.

Method E3: Extraction of PCBs from Liquid Samples.

Liquid samples (water/surfactant) were transferred to 250 ml separatory funnels. Hexane (50 ml) was added and shaken for approximately 5 minutes. The immiscible hexane and water phases were allowed to form for approximately 20 minutes. An emulsion of hexane and water was typically present, the more surfactant present in the water layer, the larger the volume of emulsion. To break the emulsion, 10 ml acetone was added in to each funnel to achieve clear separation of hexane phase and the aqueous phase. The upper solvent layer was gently transferred to another separatory funnel. The bottom aqueous layer was re-extracted with a second aliquot of 50 ml hexane, following the steps outlined above. This procedure to extract the PCBs from the aqueous layer was performed a total of three times. The hexane phases from the three extractions were pooled together and filtered through Fluorosil columns. A 1 ml sample of the hexane extract was transferred ml to GC vial and analyzed in the gas chromatograph for PCBs. The volume of the hexane extract was then adjusted with additional hexane as needed to obtain a gas chromatographic response within the range of the calibration curve.

Method E4: Extraction of PCBs from Oil Samples.

To measure PCBs in the oil phase, the oil samples were diluted with hexane (1:10 volumetric ratio) and filtered through Fluorosil cartridge columns. The filtrate was collected in glass tubes and the volume of the each collected sample was adjusted with hexane. A 1 ml aliquot of each filtrate sample was transferred a glass vial and analyzed for PCB concentration (see Method A1). The volume of the hexane filtrate was adjusted with additional hexane as needed to obtain a gas chromatographic response within the range of the calibration curve.

Method E5: Extraction of Sediment Samples.

Sediment samples were dried in a vacuum oven (24 hours at 110° C.), and their dry weight was determined. The dry soil was transferred to a cellulose extraction thimble (Whatman) in a soxhlet extraction apparatus (Kimble) which contained a condensing tube and 500 mL flat bottom flask. A 50% hexanes and 50% acetone solution (300 mL) was added to the flask, and by heating the solution, the PCB's are extracted for 24 hours and collected in the organic phase. Upon cooling, the solution volume is reduced to 30 mL using a Turbo Vap II (Zymark Corporation, Hopkington, Mass. 01748), and transferred to a 250 mL separatory funnel. A 2% sodium chloride solution (30 mL) (J. T. Baker) is added to the funnel and the solutions are shaken for one minute. When the layers separate completely, the sodium chloride solution is discarded. To the separatory funnel, 10 mL of a 3M sodium hydroxide (J. T. Baker, pellets) solution is added and the solutions are mixed for one minute. Upon formation of separate layers, the sodium hydroxide is discarded. Next, 10 mL of concentrated sulfuric acid (J. T. Baker, A.C.S. reagent) is added to the separatory funnel, and the solutions are mixed for one minute, then the acid layer is discarded. The acid step is repeated until all discoloration is removed from the organic phase. Finally, another 20 mL of 2% sodium chloride solution is added to the separatory funnel and the solutions are shaken for one minute. The salt solution is discarded.

The organic phase is passed through a drying column (Supelco Drying Column with reservoir 60 mL×19 mm×10 cm). This column is composed of a bottom layer of dry sodium sulfate (4 g) (EM Science, anhydrous, granular) followed by a mixture of copper powder and Fluorisil above (1:1 ratio by weight) (Sigma Aldrich, magnesium silicate, activated), then another layer of sodium sulfate (1 g) above. The organic phase is passed through this column and collected in glass tubes. The column is rinsed with 20 mL of hexanes and this rinsing portion is added to the solution previously collected. The organic solution is concentrated to 10 mL by heating the tubes in an oil bath at 60° C. and passing nitrogen gas over the surface of the solution. The solutions are diluted with hexanes to yield a total volume of 20 mL per sample.

Method E6: Extraction of PCB Surfactant Samples.

Liquid samples (water/surfactant) were transferred to 250 mL separatory funnels. Hexanes (50 mL) were added to the funnel and the mixture was shaken for 20 minutes. An emulsion forms but it is removed by adding 10 mL of acetone and gently shaking the funnel. The upper layer (organic phase) is transferred to another separatory funnel. The extraction process is repeated twice more. The hexanes solution is passed through a Fluorisil column (11 cm of Fluorisil) (Sigma Aldrich, magnesium silicate, activated), and evaporated to a total volume of 10 mL by heating the tubes in an oil bath at 60° C. and passing nitrogen gas over the surface of the solution. The solution is diluted with hexanes to a final volume of 20 mL per sample.

Method E7: Preparation of Oil Samples.

To measure PCB's in the oil phase, the oil samples were diluted with hexanes (1:5) and passed through a Fluorisil column (15 cm of Fluorisil) (Sigma Aldrich, magnesium silicate, activated). The column is rinsed with three 20 mL portions of hexanes. Once all the hexanes solutions were collected in a glass tubes, the solution volumes were evaporated to 10 mL by heating the tubes in an oil bath at 60° C. and passing nitrogen gas over the surface of the solution. The solutions were diluted with hexanes to a final volume of 20 mL per sample.

Method A1: GC Analysis of PCBs.

The concentration of PCB in the hexane extracts or filtrates (see methods above) was analyzed by gas chromatography using a Varian 3500 GC. The GC was equipped with a ⁶³Ni Electron Capture Detector (ECD), J & W megabore DB column 608 (size 30 m×0.50 mm), and an autosampler (Type 8200). The GC injector temperature setting was 250° C. and the detector was set at 325° C. The initial column temperature was set at 140° C. with an increase in temperature at the rate of 5° C./minute, up to a maximum of 280° C. The final hold time at the end of the temperature program was 6 minutes. The total run time was 30 minutes per sample. The detector attenuation and range were 2 and 10, respectively. Helium and nitrogen were used as the carrier and make up gases at a flow rate of 1 ml and 10 ml/minutes, respectively. All data and chromatograms were analyzed using Varian Star Workstation software. A three point calibration curve was created each sample day to standardize the ECD response and determine the concentration of PCBs.

Method A2: GC Analysis of PCBs.

The concentration of PCBs in the hexane extracts or filtrates (see methods above) were analyzed by gas chromatography using a Hewlett Packard 5890 GC. The GC was equipped with a ⁶³Ni Electron Capture Detector (ECD), HP Ultra 2 capillary column (size 50 m long×0.20 mm i.d.), and an autosampler (HP 7673A). The GC injector temperature setting was 220° C. and the detector was set at 325° C. The initial column temperature was set at 140° C. with an increase in temperature at the rate of 2° C./minute, up to a maximum of 300° C. The total run time was 81 minutes per sample. Helium and nitrogen were used as the carrier and make up gases at flow rates of approximately 0.5 ml and 5 ml/minutes, respectively. All data and chromatograms were analyzed using Hewlett Packard Chemstation software. A three point calibration curve was created for each sample set by averaging responses for standards run at least every 22 samples.

### Experiment 1

### Demonstration of the Oil/Surfactant Method

In Experiment 1, we show that surfactant and water at one concentration of surfactant can remove PCB's from sediment; that oil and water can remove PCB's from sediment and finally; oil and surfactant can remove PCB's better than surfactant alone and better than oil alone.

The study was conducted in seven 100-ml glass tubes with screw caps fitted with Teflon-lined septa. These tests were conducted in duplicate. Contaminated lake sediment (25 g wet weight, 16.5 g dry weight) was placed into each tube. The first tube (A) was labeled as the base case and received no additional treatment. The second tube (B) was used as the control and received 25 ml water as the treatment. The sediment in the third tube (C) was treated with or 25 ml of 5% surfactant in water. In tube (D), 5 g corn oil was first mixed (2 minutes by hand) into the soil, then 25 ml water was added. A similar sample (E) was first treated with 25 ml water followed by 5 ml corn oil. Test sample (F) was treated first with 5 g corn oil and mixed for 2 minutes by hand, followed by addition of 25 ml of the 5% surfactant. Sample (G) was treated first with 25 ml of the 5% surfactant solution followed by 5 g of corn oil. The tubes were sealed with the screw caps and shaken on a rotary shaker for 4 hours.

The samples were then let stand for about 24 hours to separate the various phases (layers). The oil (top layer in treatments D, E, F, and G) and water (middle layer in tubes D, E, F, and G) were withdrawn using pasture pipettes and transferred to separate vials. All the separated PCB samples (oil, water and sediment layers) were shipped to Environmental Quality laboratories, Inc. (Sterling Heights, Mich.) for the extraction and analysis of PCBs. The treatment details are given in Table 2.

TABLE 2
Summary of Treatment in the Tubes in Experiment 1

| Tube | |
|---|---|
| Number | Treatment Protocol |
| A | 25 g sediment only |
| B | 25 g sediment + 25 ml water |
| C | 25 g sediment + 25 ml 5% surfactant |
| D | 25 g sediment + 5 g corn oil then 25 ml water |
| E | 25 g sediment + 25 ml water then 5 g corn oil |
| F | 25 g sediment + 5 g corn oil then 25 ml of 5% surfactant |
| G | 25 g sediment + 25 ml of 5% of surfactant then 5 g corn oil |

Materials and Sources:

PCBs, Aroclor 1254, AccuStandard, Inc. 25 Science Park, New Haven, Conn. 06511

Mazola Corn Oil, CPC International, Inc., Englewood Cliffs, N.J. 07632.

Super concentrated Matrix (surfactant) Rhema Products, Inc. Memphis, Tenn.

The results of the duplicate tests (designated 1 and 2) are presented in Table 3. The following observations may be directly from the data. PCB tests in surfactant bearing water were deemed to be improperly extracted for PCB's. Therefore, these data are not discussed herein.

TABLE 3
PCB Concentration in different phases

| | | Sediment | | |
|---|---|---|---|---|
| | | mg/kg dry | Water | Oil |
| Tube | Treatment | weight | mg/kg | mg/kg |
| A1 | sediment only | 360 | N/A | N/A |
| A2 | | 440 | N/A | N/A |
| A | | 400 | | |
| average | | | | |
| B1 | sediment + water | 380 | 2.2 | N/A |
| B2 | | 550 | 2.2 | N/A |
| B | | 465 | 2.2 | |
| average | | | | |
| C1 | sediment + surfactant | 210 | 21 | N/A |
| C2 | | 280 | 5.8 | N/A |
| C | | 245 | 13 | |
| average | | | | |
| D1 | sediment + oil + then water | 21 | 2.4 | 660 |
| D2 | | 100 | 2.7 | 277 |
| D | | 61 | 2.6 | 469 |
| average | | | | |
| E1 | sediment + water then oil | 34 | 4.3 | 550 |
| E2 | | 170 | 1.4 | 202 |
| E | | 102 | 2.9 | 376 |
| average | | | | |
| F1 | sediment + oil then surfactant | 16 | 2.9 | 890 |
| F2 | | 28 | 7.4 | 260 |
| F | | 22 | 5.2 | 575 |
| average | | | | |
| G1 | sediment + surfactant then oil | 17 | 2.1 | 870 |
| G2 | | 33 | 6.9 | 391 |
| G | | 25 | 4.5 | 631 |
| average | | | | |

Note: (1, 2) designate duplicate runs, sediment is 25 g wet weight, water is 25 ml, surfactant is 25 ml at 5% by volume, oil is 100% corn oil.

The average recovery of PCB's from the untreated sediment (A) was 400 mg/kg dry sediment. The expected result was 500 mg/kg. Therefore, the recovery of PBC's by the extraction method used for the sediments is around 80%.

The extraction with water alone (B) resulted in recovery of 465 mg PCB's/kg dry sediment plus a small amount (2.2 mg/kg) in the water phase. Clearly, water addition alone has little influence on the PCB concentration in the sediment.

The addition of surfactant (25 ml of 5% surfactant in water) alone (C) results in a higher removal of PCB's from the sediment than water alone. The average PCB concentration remaining on the sediment for this treatment was 245 mg/kg dry weight, or approximately 45% removal in a single equilibrium extraction.

Treatments D and E (oil and water extraction) are considered herein as a single test because the variability in the results do not allow for accurate assessment of the influence of the order of addition. With oil and water extraction, an average of 82 mg PCB/kg sediment remained on the sediment, representing a removal of approximately 81%. The resulting concentration in the oil phase was 422 mg PCB's/kg oil.

Treatments F and G (oil and surfactant extraction) are considered herein as a single test because the variability in the results do not allow for accurate assessment of the influence of the order of addition. With oil and surfactant extraction, an average of 23 mg PCB/kg sediment remained on the sediment, representing a removal of approximately 95%. The resulting concentration in the oil phase was 602 mg PCB's/kg oil.

### Experiment 2

### Extraction with Surfactant Alone

In this experiment we show that PCB removal from sediments is surfactant concentration dependent. Spiked Lake Lansing sediment was prepared as described for Experiment 1. Six pairs of glass screw cap tubes were prepared by addition of 25.0 g of wet sediment plus 25.0 g of liquid to each tube. The liquid consisted of 0%, 2.5%, 5%, 10%, 20%, or 30% surfactant (Rhema superconcentrated Matrix) by volume. Each tube was shaken for 4 hours and the sediment was allowed to settle. The liquid layer from each tube was then removed and centrifuged. The recovered solids from the centrifugation step were returned to the original settled solids. Solids and centrate were analyzed for PCB's. The results are presented in Table 4.

TABLE 4
Removal of PCB from Lake Lansing
Spiked Sediment using Surfactant Alone

| | | PCB | | |
|---|---|---|---|---|
| | | concentration mg/kg | | Sample Vol (g DW) |
| Treatment | | Sediment | Liquid | Sediment |
| 1a | Sediment + 0% Soap | 283 | 1.75 | 17.29 |
| 1b | | 168 | 1 | 17.07 |
| Avg | | 226 | 1.38 | 17.18 |
| 2a | Sediment + 2.5% Soap | 250 | SNR | 18.07 |
| 2b | | 164 | SNR | 17.61 |
| Avg | | 207 | | 17.84 |
| 3a | Sediment + 5% Soap | 134 | SNR | 18.01 |
| 3b | | 146 | SNR | 16.51 |
| Avg | | 140 | | 17.26 |
| 4a | Sediment + 10% Soap | 127 | SNR | 17.16 |
| 4b | | 93 | SNR | 16.15 |
| Avg | | 110 | | 16.66 |
| 5a | Sediment + 2.0% Soap | 72 | SNR | 17.35 |
| 5b | | 68 | SNR | 16.56 |
| Avg | | 70 | | 16.96 |
| 6a | Sediment + 3.0% Soap | 61 | SNR | 17.15 |
| 6b | | 55 | SNR | 18.90 |
| Avg | | 58 | | 18.03 |

SNR: sample data not retained; method of analyzing PCB's in surfactant solution unreliable.

### Experiment 3

### Critical Lamination of Oil in Waterborne Surfactant

To define the minimum amount of oil recoverable as a defined phase, two test series were performed; one with detergent and water; the second with detergent and water in the presence of Lake Lansing sediment. Oil was added to a test tube (I.D.=0.862 inch) containing twenty-five ml of surfactant in water. The detergent concentration ranged from 0-20%. The mixture was shaken then left to separate quiescently. The presence of discernable oil phase was observed after 10 minutes. If no clear layer was present, additional oil was added and the process repeated. The second series was set up to contain 25 g wet-weight Lake Lansing sediment plus 25 mL of surfactant in water. Oil was added dropwise followed by shaking and settling until a clear oil-water interface formed. The weight of oil was carefully measured to be 18.6±1.0 mg per drop. The results of the tests are presented in Table 5.

FIG. 1 is a plot of the results of Experiment 3. This figure clearly shows that the chosen surfactant is very efficient in improving the removal of oil from water. The adverse effects of lake sediment on oil recovery seem to be diminished at surfactant concentrations above 10%.

TABLE 5
Minimum Critical Phase Separation

| | mg oil to create phase | mg oil to create phase |
|---|---|---|
| % Surfactant | (No sediment present) | (25 g Lake Lansing Sediment) |
| 0 | 17.4 | 27.9 |
| 5 | 10.5 | 17.4 |
| 10 | 7.0 | 10.5 |
| 15 | 7.0 | 7.0 |
| 20 | 7.0 | 7.0 |

### Experiment 4

### Demonstration that the PCB is Preferentially Distributed to the Foam

PCB contaminated sediment samples were prepared as before. Samples 1a and 1b were controls to determine the concentration of PCBS in sediment in the presence of 25 ml water. These are consistent with the previous samples. Samples 2a, 2b, and 2c were prepared by adding 25 ml 10% surfactant to the sediment and separation as before. This time, the recovered water was shaken to produce foam and the foam recovered separately from the water. Each sample was shaken and fractionated three times sequentially such that a total of 5 ml foam equivalent was recovered and 20 ml water remained. There is a 5:1 concentration in the foam samples.

TABLE 6
Removal of PCB from Lake Lansing Spiked Sediment
using Surfactant Alone and Foam Fractionation

| | | PCB concentration μg/mL | | |
|---|---|---|---|---|
| Treatment | | Sediment | Liquid | Foam Fraction |
| 1a | Sediment + | 526 | 1 | NA |
| 1b | 0% Soap | 236 | 1 | NA |
| Avg | | 381 | 1 | NA |
| 2a | Sediment + | 240 | 15 | 65 |
| 2b | 10% Soap | 236 | 16 | 80 |
| 2c | | 230 | 17 | 73 |
| Avg | | 235 | 16 | 73 |

Foam = 5 ml water equivalents
Liquid = 20 ml in fractionated samples
Liquid = 25 ml in fractionated sample

### Experiment 5

### Demonstration of Closure of Mass Balance

Due to analytical problems in analyzing PCBs in oil and water borne surfactant solutions, considerable care was taken to improve analytical methods in oil and surfactant. It was the intent of this experiment to demonstrate that PCB that is extracted from sediment samples is recovered in the oil or the surfactant layers. In this experiment, 25 g wet weight spiked Lake Lansing sediment was mixed with 25 ml water (control), with 25 g of surfactant (10% by volume in water) and with 25 g of surfactant (10% by volume in water) plus 5 g corn oil. The control was performed in duplicate and the other tests were performed in triplicate. The charged sample was targeted to contain a total of 9000 μg PCB (500 mg/kg dry weight in 18 g dry weight sediment). The results are presented Table 7.

TABLE 7
Results of Experiment 5 to Close the Mass Balance on 3
Phase Separation

| | | | | |
|---|---|---|---|---|
| Phase | Sample 1 | Sample 2 | Sample 3 | Average |

Control (Spiked Sediment Extracted with Water)
(μg PCB recovered in each phase)

| | | | | |
|---|---|---|---|---|
| Sediment | 9380 | 10900 | not performed | 10140 |
| Water | 203 | 149 | not performed | 176 |
| Total Recovered | 9583 | 11049 | | 10316 |
| Percent recovered | 105% | 123% | | 115% |

Spiked Sediment Extracted with Equal mass
of 10% Surfactant in Water)
(μg PCB recovered in each phase)

| | | | | |
|---|---|---|---|---|
| Sediment | 2858 | 3393 | 3338 | 3196 |
| 10% surfactant | 6404 | 3289 | 4556 | 4750 |
| Total Recovered | 9262 | 6682 | 7894 | 7946 |
| Percent recovered | 103% | 74% | 88% | 88.3% |

Spiked Sediment Extracted with Equal mass
of 10% Surfactant in Water)
(μg PCB recovered in each phase)

| | | | | |
|---|---|---|---|---|
| Sediment | 213 | 553 | 142 | 303 |
| 10% surfactant | 270 | 189 | 376 | 278 |
| Oil | 9708 | 7049 | 5934 | 7563 |
| Total Recovered | 10191 | 7791 | 6452 | 8145 |
| Percent recovered | 113% | 87% | 72% | 90% |

These results demonstrate that the PCB's can be effectively analyzed in all component phases and that the mass balance of PCB's in the various phases has been closed. The distribution of PCB between the phases is consistent with previous observations. With 10% surfactant used as the lone extractant, 40% of the PCB remains in the sediment. When oil is added for dual phase extraction, 3.6% of the PCB's remain in the sediment while 3.4% remain in the surfactant and approximately 93% are recovered in the oil phase.

Because the sediment recovered in these tests is wet, containing approximately 28% liquid and 72% dry solids, the PCB's remaining in the liquid portion contribute significantly to the total mass of PCB's recovered in the sediment phase. It may be shown from engineering principles that these PCB's in the liquid fraction may be removed from the sediment by a clean water rinse.

### Experiment 6

### Timed Mixing Study with Weathered Sediment

To further demonstrate the utility of the process in weathered samples, a sample of PCB contaminated sediment from mouth of the Acushnet River in the New Bedford Harbor, New Bedford, Mass. A second purpose of the test was to preliminarily investigate the mixing requirements to transfer PCB's within a three phase system. The experimental system consisted of a 600 ml glass beaker, a twin bladed mixing paddle, and a Phipps-Bird six member gang stirrer. A 175 g wet weight (39.4% dry weight) of river sediment was placed into the beaker followed by 350 ml of 10% surfactant in water. A layer of 35 ml corn oil was then carefully placed on top of the water layer. The twin bladed mixing paddle was adjusted so that the bottom blade (¾ inch paddle height) was in the sediment layer and the upper (⅜ inch height) blade was in the middle of the surfactant/oil interface. The mixing paddle diameter was ¼ inch less than the diameter of the beaker. The mixing paddle was then rotated at a slow speed (25 rpm) specifically to avoid any direct contact between the oil phase and the sediment layer. Duplicate samples of sediment were measured for PCB content and served as the time zero reference. Duplicate samples of sediment and the waterborne surfactant were recovered from the beaker after 240 minutes of mixing. Duplicate samples (0.5 ml each) of the oil layer were removed after 15, 30, 60, 120, and 240 minutes of mixing.

Results of Experiment 6 are presented as concentration data and total mass recovery in each phase. The right hand column shows the total mass of PCB at the start and finish of the test. These data indicate that full recovery of PCB (105%) was achieved in the three phases. The initial concentration of PCB in the sediment was 1600 mg/kg dry weight. The final concentration of PCB in the sediment was 330 mg/kg, representing 80% removal of PCB from the sediment. The concentration of PCB in the oil phase rose linearly with time to a final concentration of 280 mg/kg (total mass 8600 μg). The linearity of the concentration increase and the relatively low final concentration in the oil phase are taken as an indication that the stirring speed of 25 rpm was insufficient to bring the contents of the beaker to equilibrium within the 240 minute mixing time. The distribution of PCB mass between the phases is shown in FIG. 2.

TABLE 8
A timed mixing test with weathered PCB contaminated River Sediment*

| | | | | | | Mass | Total Mass |
|---|---|---|---|---|---|---|---|
| | | PCB | PCB mg/kg in | | Mass | PCB (μg) in | (μg) |
| Time (Minutes | PCB | mg/kg in the | the water- | Mass | PCB | the water- | in the System |
| of Mixing at 25 | mg/kg in the oil | sediment | borne | PCB (μg) | (μg) in the | borne | (based on sample |
| rpm) | layer | dry wt basis | surfactant | in the oil layer | sediment | surfactant | averages) |
| 0 | 0 | 1104 | 0 | 0 | 76964 | 0 | 114500 |
| 0 | 0 | 2181 | 0 | 0 | 152092 | 0 | |
| 15 | 24 | ND | ND | 840 | ND | ND | |
| 15 | 28 | ND | ND | 980 | ND | ND | |
| 30 | 40 | ND | ND | 1360 | ND | ND | |
| 30 | 44 | ND | ND | 1496 | ND | ND | |
| 60 | 84 | ND | ND | 2772 | ND | ND | |
| 60 | 64 | ND | ND | 2112 | ND | ND | |
| 120 | 156 | ND | ND | 4992 | ND | ND | |
| 120 | 164 | ND | ND | 5248 | ND | ND | |
| 240 | 284 | 267 | 284 | 8804 | 18604 | 99400 | 120500 |
| 240 | 276 | 392 | 224 | 8556 | 27298 | 78400 | |

ND = not determined

### Experiment 7

### Effect of Oil Concentration

In this experiment we show that PCB removal from sediments is only slightly dependent upon oil concentration. Spiked Lake Lansing sediment was prepared as described for Experiment 1. Five sets of triplicate treatments were prepared in glass screw cap tubes by addition of 25.0 g of wet sediment (18.0 g dry weight) plus 25.0 g of liquid to each tube. The five treatments were as follows:

1:25 g lake sediment+20 ml, 5% Surfactant in water+5 ml corn oil

2:25 g lake sediment+24 ml 5% Surfactant in water+1 ml corn oil

3:25 g lake sediment+20 ml of 15% Surfactant in water+5 ml oil

4:25 g lake sediment+24 ml of 15% Surfactant in water+1 ml oil

5:25 g lake sediment+25 ml water (control)

The liquid consisted of water, or water plus surfactant (Rhema super-concentrated Matrix) by volume, or corn oil. Each tube was shaken for 4 hours and the sediment was allowed to settle. The liquid layer from each tube was then removed and centrifuged. The recovered solids from the centrifugation step were returned to the original settled solids. Two liquid phases were recovered in treatments 1-4 and consisted of the water/surfactant layer and the oil layer. There was no oil in the control (treatment 5).

The sediment solids and the recovered centrates were analyzed for PCB's (Table 9). The triplicate results for phase for each treatment were summed to estimate the total recovered mass of PCB's. The average recovery in each phase is presented in the final column of Table 9. The data indicate that there is only a small redistribution of recovery between the phases that is directly due to the amount of oil used. For 5% surfactant, 91% removal from sediment was obtained with 5 ml oil, whereas, 84% was achieved with 1 ml oil. For 15% surfactant, 86% was removed from with 5 ml oil versus 76% with 1 ml oil. The potential for finding an optimum cost advantage for single, or countercurrent, or multiple extractions with small volumes of oil is implied from these trends.

TABLE 9
Mass Recovery of PCBs in Three Phases Using Two Oil
Concentrations and Two Concentrations of Surfactant.

| | | | | % of |
|---|---|---|---|---|
| PCBs in μg (in triplicate treatments) | | | | Average |
| I | II | III | Average | Recovery |

Treatment 1) 25 g Lake Lansing sediment (18 g dry wt) +
20 ml of 5% Surfactant in water + 5 ml Corn Oil

| | | | | | |
|---|---|---|---|---|---|
| Sediment | 322 | 664 | 182 | 389 | 8.6% |
| Surfactant layer | 138 | 78 | 90 | 102 | 2.3% |
| Oil layer | 4460 | 3820 | 3760 | 4013 | 89.1% |
| Total | 4920 | 4562 | 4032 | 4505 | 100% |

Treatment 2) 25 g Lake Lansing Sediment (18 g dry wt) +
24 ml of 5% Surfactant in water + 1 ml Corn Oil

| | | | | | |
|---|---|---|---|---|---|
| Sediment | 416 | 670 | 838 | 641 | 15.9% |
| Soap layer | 168 | unavailable | 72 | 120 | 3.0% |
| Oil layer | 3700 | 3220 | 2860 | 3260 | 81.1% |
| Total | 4284 | 3890 | 3770 | 4021 | 100.0% |

Treatment 3) 25 g Lake Lansing Sediment (18 g dry wt) +
20 ml of 15% % Surfactant in water + 5 ml Corn Oil

| | | | | | |
|---|---|---|---|---|---|
| Sediment | 302 | 464 | 722 | 496 | 14.2% |
| Surfactant layer | unavailable | 84 | 156 | 120 | 3.4% |
| Oil layer | 2760 | 2980 | 2900 | 2880 | 82.4% |
| Total | 3062 | 3528 | 3778 | 3496 | 100.0% |

Treatment 4) 25 g Lake Lansing Sediment (18 g dry wt) +
24 ml of 15% Surfactant in water + 1 ml Oil

| | | | | | |
|---|---|---|---|---|---|
| Sediment | 1110 | 930 | 700 | 913 | 24.3% |
| Surfactant layer | 120 | 144 | 24 | 96 | 2.6% |
| Oil layer | 2720 | 3120 | 2420 | 2753 | 73.2% |
| Total | 3950 | 4194 | 3144 | 3763 | 100.0% |

Treatment 5) Control: 25 g Lake Lansing Sediment (18 g dry wt) +
25 ml water ( No soap and No Oil)

| | | | | | |
|---|---|---|---|---|---|
| Sediment | 4208 | 3124 | 6332 | 4555 | 99.6% |
| Water layer | 12 | 24 | 18 | 18 | 0.4% |
| Total | 4220 | 3148 | 6350 | 4573 | 100.0% |

### Experiment 8

### PCB Removal from Water vs. Surfactant Concentration

In this experiment we show that surfactant addition to the water phase improves the transfer of PCB's from the water phase to the oil phase. In this two-phase extraction, Rhema super-concentrated Matrix was used as the surfactant and Mazola corn oil was used in the oil phase. The experimental surfactant range tested was from 0 to 30% by volume. Each test condition was prepared in duplicate. Three control water samples containing no surfactant and 5 mL of oil were run concurrently.

Using 50 mL glass screw cap tubes, 25 mL of varying percentages of surfactant solutions were spiked with 5 mg of a 10 mg/mL PCB acetone solution. The tubes were shaken to provide equal distribution of PCB throughout the surfactant, and 5 mL of corn oil was placed on top of the surfactant layer. The samples were shaken for four hours at 85 rpm using a Series 25 Incubator Horizontal Shaker (New Brunswick Scientific Co.), then centrifuged for 10 minutes at 2,000 rpm (Beckman Model TJ-6 Centrifuge) to improve phase separation. Immediately following, the oil layer was removed by pipette and transferred to a separate glass vial. If any water was transferred with the oil, the sample was centrifuged again and the water was removed and placed back in the original vial. The oil layer was diluted with 20 mL of hexanes, and passed through a Fluorisil column. The samples were collected in a 100 mL graduated tube, and the column was rinsed three times with 20 mL portions of hexanes to capture any remaining PCB's. The solution was concentrated to 10 mL by heating the tubes to 60 degrees and evaporating the sample volume with nitrogen gas. The surfactant phase was extracted with three 50 mL portions of hexanes using a 250 mL separatory funnel. The organic phase was transferred to another separatory funnel, and dried after passing the solution through a Fluorisil column. The solutions were concentrated to 10 mL using heat and evaporation. Samples for both surfactant and oil phases were diluted to exactly 20 mL with hexanes and transferred to 20 mL scintillation vials for storage. A portion of each sample was analyzed by Gas Chromatography for the PCB concentration in the hexane solution.

The results of the separate experiments are compiled in Table 10. Each result is an average value obtained from duplicate samples. The percent PCB in each phase was determined by taking the amount in that phase and dividing it by the total PCB mass recovered. The total mass of PCB's recovered is recorded as the sum of the mass values from the oil and surfactant samples.

TABLE 10
Total PCB mass extracted with varying surfactant concentration

| | PCB mass | | PCB mass in | % PCB in | |
|---|---|---|---|---|---|
| Surfactant | in 5 mL oil | % PCB in | 25 mL surfactant | surfactant | Total PCB mass |
| Concentration (%) | (μg) | oil phase | (μg) | phase | extracted (μg) |
| 0 | 1854 | 52 | 1712 | 48 | 3566 |
| 0 | 975 | 37 | 1675 | 63 | 2650 |
| 0 | 1249 | 39 | 1940 | 61 | 3189 |
| 0.5 | 3214 | 96 | 140 | 4 | 3354 |
| 1 | 3299 | 91 | 317 | 9 | 3616 |
| 1 | 3174 | 95 | 167 | 5 | 3341 |
| 1.5 | 3397 | 97 | 100 | 3 | 3497 |
| 2 | 3193 | 95 | 184 | 5 | 3377 |
| 2.5 | 3472 | 96 | 152 | 4 | 3624 |
| 3 | 3944 | 99 | 52 | 1 | 3996 |
| 3 | 4211 | 99 | 60 | 1 | 4271 |
| 3.5 | 4100 | 99 | 56 | 1 | 4156 |
| 4 | 4676 | 98 | 91 | 2 | 4767 |
| 4 | 4139 | 99 | 54 | 1 | 4193 |
| 4.5 | 4337 | 99 | 32 | 1 | 4369 |
| 5 | 4024 | 99 | 49 | 1 | 4073 |
| 5 | 4217 | 99 | 36 | 1 | 4253 |
| 6 | 3708 | 99 | 20 | 1 | 3728 |
| 6 | 3875 | 99 | 37 | 1 | 3912 |
| 9 | 3862 | 99 | 25 | 1 | 3887 |
| 9 | 4022 | 99 | 44 | 1 | 4066 |
| 12 | 3870 | 99 | 24 | 1 | 3894 |
| 12 | 3958 | 99 | 27 | 1 | 3985 |
| 30 | 3880 | 99 | 47 | 1 | 3927 |

It is evident from comparison of the control samples with the surfactant samples that a larger portion of the PCB mass is being transferred from the surfactant/water phase than from water alone (control). This result confirms a mechanism similar to that shown in Experiment 3, which demonstrates the surfactant's unique ability for de-emulsification. The oily PCB is in effect being rejected from the soap into the oil phase where it remains because of the immiscibility of the two phases. In addition, the data show that a smaller portion of PCB mass remains in the surfactant/water phase (average of 82 μg) then in water alone (average of 1776 μg).

From the total amount of PCB recovered, we noted that concentrations of surfactant ranging from 3-30% by volume in water removed similar amounts of PCB material. This experiment indicates the surfactant is very effective at low concentrations. A summary of the PCB mass distribution in oil and surfactant phases is plotted in FIG. 3. There is an exponential increase of the PCB mass at low concentrations in the oil phase as well as a concurrent decrease in PCB mass in the surfactant phase. At higher concentrations the PCB mass extracted becomes almost linear with surfactant concentration.

### Experiment 9

### Motor Oil vs. Corn Oil

This experiment demonstrates that the substitution of another oil (Motor oil) for the oil phase in Experiment 8 will produce similar results for PCB mass extraction. In this case the brand used was Citgo SAE-30 non-detergent motor oil. Experiment 8 was repeated using the same range of surfactant concentrations (25 mL volume), each spiked with 500 μL of a 10 mg/mL PCB (5 mg) acetone solution. The volume of the oil remained 5 mL.

Following the same procedure as in Experiment 8, the 50 mL screw cap tubes were shaken at 85 rpm for four hours on a Incubator Shaker (New Brunswick Scientific Co.), and then centrifuged for 10 minutes at 2,000 rpm on a Beckman Model TJ-6 Centrifuge. The oil phase was separated by pipette and placed in a separate glass tube. The oil sample was diluted with 20 mL of hexanes and run through a Fluorisil column. The column was rinsed with 3-20 mL portions of hexanes. The dilute sample was concentrated to 10 mL then diluted to a final volume of 20 mL, and transferred to a 20 mL scintillation vial for storage. The surfactant solution was extracted three times with 50 mL portions of hexanes. After each extraction the organic phase was transferred to another separatory funnel. The solution was dried upon passing it through a Fluorisil column. The sample solution was concentrated to 10 mL then diluted to 20 mL with hexanes, and transferred to 20 mL scintillation vials for storage. A small portion of the sample was taken for GC analysis.

The experimental results are presented in Table 11. Each result is an average value obtained from duplicate samples. The percent PCB in each phase was determined by taking the amount in that phase and dividing it by the total PCB mass. The total mass of PCB's recovered is recorded as the sum of the mass values from the oil and surfactant samples.

TABLE 11
Total PCB mass extracted with varying surfactant concentration

| Surfactant | PCB mass | % PCB in | PCB mass in | % PCB in | Total PCB mass |
|---|---|---|---|---|---|
| Concentration (%) | in 5 mL oil (? g) | oil phase | 25 mL soap (? g) | soap phase | extracted (? g) |
| 0 | 1136 | 27 | 3070 | 73 | 4206 |
| 1 | 3833 | 95 | 196 | 5 | 4029 |
| 3 | 3570 | 95 | 175 | 5 | 3745 |
| 4 | 3470 | 99 | 34 | 1 | 3504 |
| 5 | 3728 | 99 | 53 | 1 | 3781 |
| 6 | 3586 | 99 | 33 | 1 | 3619 |
| 9 | 3447 | 98 | 57 | 2 | 3504 |
| 12 | 3252 | 98 | 66 | 2 | 3318 |

These data are graphically shown in FIG. 4. An exponential increase in PCB mass in oil occurs immediately and quickly becomes almost linear with increasing surfactant concentration. The oil phase contains 98-99% of the PCB mass with surfactant concentrations of 4-12%. An exponential decrease in PCB mass in the surfactant concentration indicates that PCB's are being rejected from the surfactant phase more than the control tube, which contains water alone. Finally, the effective range of surfactant concentration does not change when altering the type of oil used in this experiment.

The use of another type of oil in this experiment had no effect on the ability for PCB's to be removed from the surfactant solution. We can conclude that the substitution of any oil in a two-phase (surfactant and oil) or three-phase extraction (soil-surfactant-oil) would produce similar results, and effectively capture the majority of the PCB mass.

Experiment 10

### PCB Extraction using Hopper Device

A laboratory model mixing hopper with screw conveyance was constructed. FIG. 5 shows the side view of the reactor. A 6½ inch diameter stainless steel pipe section with a height of 8½ inches was used as the body of the reactor chamber (the hopper). The body of the reactor was welded to a 25½ inch screw trough such that the trough made a 30° angle to the horizontal. A sectional base plate was welded to the bottom of the pipe and the sides of the trough to make a water tight seal. Several portals (⅜ inch pipe nipples) were placed on the body of the reactor for convenience in removing reaction materials during testing.

A variable speed motor was mounted above the body of the reactor to operate a dual paddle mixing shaft. Both paddles extended to cover the entire inside diameter of the reactor body less ¼ inch clearance at each wall. One paddle of approximately 1 inch height was placed at the bottom of the reactor body to move the settled solids. The second paddle of approximately ⅓ inch height was placed at a height to mix the waterborne surfactant.

A second variable speed motor was placed parallel with the bottom of the screw trough to operate the screw. The screw was constructed of a ⅜ inch stainless steel rod. The helical portion of the screw was constructed with ⅛ inch thick stainless steel plate. The helix diameter was 1⅜ inch with a 1 inch separation between rotations and approximately a 30° pitch.

A soil extraction was performed using the apparatus illustrated in FIG. 5 using PCB spiked sandy loam soil from MBI. The total operational volume of the Hopper was approximately 3 liters. The hopper was charged with 1.0 kg soil and 1500 mL of 7.5% waterborne surfactant. The contents of the Hopper were mixed for 1 hour at 40 rpm. At the end of the mixing time, the contents were allowed to settle, and the soil was the surfactant was drained from the reactor. A total of 1400 mL surfactant was recovered. The soil was removed from the reactor using the screw. The surfactant was contacted with 300 mL of corn oil in a separatory funnel for 1 hour. Samples of the three phases were analyzed for their PCB content using methods E5, E6, and E7. Of the recovered PCB's, the oil phase contained 64%, the surfactant phase contained 25%. Therefore, the final mass distribution of the soil indicates 11% of PCB's remain in the soil or 89% is removed.

The soil was recharged to the reactor, and a second charge of fresh 7.5% surfactant was applied. The contents of the Hopper were mixed for 1 hour at 40 rpm. At the end of the mixing time, the contents were allowed to settle, and the soil was the surfactant was drained from the reactor. A total of 1400 mL surfactant was recovered. The soil was removed from the reactor using the screw. The surfactant was contacted with 300 mL of corn oil in a separatory funnel for 1 hour. Samples of the three phases were analyzed for their PCB content using methods E5, E6, and E7. Of the recovered PCB's, including those recovered in the previous extraction, the oil phase contained 78%, and the surfactant phase contained 16%. The final mass distribution of PCB in the soil indicated that 6.0% of PCB's remained in the soil after the second extraction. This experiment shows that a practical and simple method of soil washing may be used in conjunction with this invention. Furthermore, it is demonstrated that the principle of multiple extractions may be used to improve the final quality of the soil and that the surfactant may be cleansed of the majority of pollutant by contact with oil.

Discussion of the Results.

The results of Experiments 1, 2, and 5, indicate that it is possible to simply remove PCB's from spiked sediment samples. This laboratory test is direct evidence that we have overcome some of the difficulties inherent in the present art of soil washing and extraction. FIG. 6 is a concentration dependency plot based on the data in Experiments 1, 2 and 5. Note the high degree of linearity between the logarithm of the fraction PCB remaining in the sediment versus the logarithm of the surfactant concentration. The evidence from these data allow us to make some general statements leading to understanding the possible the mechanisms of action in this extraction. Water alone is inefficient at extracting PCB's from sediment. Oil alone is effective at extracting PCB's from sediment. Surfactant alone is effective at extracting PCB's from sediment and the efficiency of PCB removal is dependent upon surfactant concentration. The use of surfactant and oil together are superior of surfactant and oil alone, at the concentrations of materials.

Experiments 3, 4, 7, 8 and 10 demonstrate that the action of the surfactant is vital to the success of the art, and that the surfactant must be chosen to have a strong detergency (surface cleaning capacity) but must also be anti-emulsion forming such that oily materials are rejected from the surfactant/water layer.

Experiments 1, 5, 6 and 7 demonstrate that the process may be performed under conditions in which the oil, surfactant, and sediment or soil are mixed within the same mixing vessel.

Experiments 2, 8 and 9 indicate that the process may be expected to proceed under the conditions in which sediment or soil are first contacted with surfactant and where the surfactant is subsequently contacted with oil. Experiment 10 demonstrates that the process can be performed under the conditions in which the sediment and surfactant are first contacted followed by contacting of the oil and the surfactant. Experiment 10 also demonstrates that soil or sediment may be further cleansed of pollutants by multiple extractions.

Experiment 4 demonstrates an alternative method of concentrating oily materials from the surfactant phase is produce foam from the surfactant and to collect the foam. The pollutant is concentrated in the foam.

I claim:

1. A method of extracting oil-soluble contaminants from soils, sediments, or porous solids by immersing the solid in a fluid comprising a water phase and an oil phase, mixing the phases and allowing the phases to separate, wherein the contaminants are thereby concentrated in the oil phase.

2. The method of claim 1 in which the contaminated solid is first immersed with the oil phase.

3. The method in claim 1 in which the contaminated solid is first immersed with the water phase.

4. The method in claim 1 in which the contaminated solid is immersed in an emulsion of the oil phase and water phase.

5. The method of claim 1 in which the water phase comprises a surfactant.

6. The method of claim 5 in which the surfactant has high detergency and low emulsifity.

7. The method of claim 1 in which the oil is petroleum based.

8. The method of claim 1 in which the oil is vegetable oil.

9. The method of claim 8 in which the oil is derived from soy, peanuts, canola, corn, or olives.

10. The method of claim 1 in which the oil is derived solely or in-part from oily contaminants extracted from the contaminated solid.

11. The method of claim 1 in which the contact between the solid and fluid is made in a batch tank.

12. The method of claim 11 in which the contents of the tank are mechanically mixed.

13. The method of claim 11 in which the mixing of an oil layer and a water layer are allowed to form in the presence of mixing of the solid layer.

14. The method of claim 1 in which the contact between the solid and the liquid is such that one or more of the solid or liquid phases is added and removed continuously.

15. The method of claim 1 in which the fluid is removed from the presence of the solid and the fluid is reclaimed into an oil phase and a water phase.

16. The method of claim 1 in which the solid is removed from the presence of the fluid and the fluid is reclaimed into an oil phase and a water phase.

17. The method of claim 4 in which the water phase is recycled by immersion with a new solid.

18. The method of claim 6 in which the recycled water phase is adjusted to a desired surfactant concentration by addition of fresh surfactant.

19. The method of claim 4 in which the oil phase is recycled by immersing new solid.

20. The method of claim 19 in which the oil is cleaned of contaminant before being recycled.

21. The method of claim 1 in which the contaminant is a petroleum derivative.

22. The method of claim 1 in which the contaminant is a chlorinated hydrocarbon.

23. The method of claim 1 in which the contaminant is selected from the group consisting of PCB, lindane, aldane, DDT, Dioxins, polychlorinated terphenyls, atrazine, and chlorinated phenols.

24. The method of claim 1 in which the contaminant is a mixture of petroleum products and chlorinated hydrocarbons.

25. The method of claim 6 in which the contaminant is concentrated from the surfactant-bearing water phase in a foam caused by agitation or bubbling followed by separation of the foam from the remainder of the water phase before contact with the oil phase.

26. A method of analyzing the presence of an oil-soluble hydrocarbon, comprising the step of immersing a solid comprising an oil-soluble hydrocarbon in a fluid comprising a water phase and an oil phase, wherein the hydrocarbon is separated into the oil phase.

27. A method of extracting oil-soluble contaminants from soils, sediments, or porous solids by
(a) immersing the solid in a fluid comprising a water phase comprising a surfactant with high detergency and low emulsifity, wherein the contaminant enters the water phase;
(b) separating the water phase from the solid; and
(c) mixing the water phase with an oil phase, wherein contaminant enters the oil phase.
